(19) United States
(12) Patent Application Publication
(10) Pub. No.: US 2010/0258247 A1
(43) Pub. Date: Oct. 14, 2010

(54) Atmospheric pressure plasma generator

(75) Inventors: Masaru Hori, Aichi (JP); Hiroyuki Kano, Aichi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NU Eco Engineering Co., Ltd., Nishikamo-gun (JP)

(21) Appl. No.: 12/659,584

(22) Filed: Mar. 12, 2010

(30) Foreign Application Priority Data
Mar. 16, 2009 (JP) 2009-062632

(51) Int. Cl. H05H 1/24; C03C 15/00; B08B 7/00

(52) U.S. Cl. 156/345.35

(57) ABSTRACT

According to the present invention, a long electric discharge path is formed, and a workpiece is irradiated with an atmospheric plasma of a long rectangular area. An argon flow at a first gas outlet forms argon plasma by high-frequency electric power between the first and second electrodes, and the plasma is jetted as an auxiliary plasma in the longitudinal direction from the left end of a primary plasma-generating zone. Another argon flow at a second gas outlet forms argon plasma by high-frequency electric power between the third and fourth electrodes, and the plasma is jetted as an auxiliary plasma in the longitudinal direction from the right end of the primary plasma-generating zone. When high-frequency electric power is applied to the first and third electrodes, electric discharge occurs between two argon plasmas flowing from both ends of the primary plasma-generating zone. Through the electric discharge, the discharge state is maintained in the entire primary plasma-generating zone. Then, oxygen and argon are supplied through gas mixture (argon and oxygen)-supplying pipes to the plasma-generating zone, oxygen plasma is generated. The oxygen plasma is jetted through 170 second holes disposed at the bottom side wall of the cylindrical section to the outside in a direction normal to the side wall, whereby a workpiece is irradiated with oxygen plasma in a long belt-like area having a length of 50 cm.

### BACKGROUND OF THE INVENTION

1. Field of the Invention

The present invention relates to an atmospheric plasma generator which allows a workpiece to be treated with plasma under atmospheric pressure.

2. Background Art

Generally, glass substrates employed as liquid crystal display panels and other display substrates, as well as a variety of semiconductor substrates, are cleaned through irradiation of the surfaces thereof with a plasma generated from an oxygen-containing gas under atmospheric pressure. In the future, atmospheric plasma is envisaged to find a wider range of uses such as cleaning and sterilization of surfaces of objects.

When plates (e.g., substrates to be treated) and films to be treated having a large area are plasma-treated, an elongated rectangular area of such a workpiece is irradiated with plasma while the workpiece is conveyed, to thereby enhance treatment rate. Considering this manner of treatment, atmospheric plasma treatment is a very useful technique, as it enables continuous treatment.

In plasma generators providing such an elongated rectangular irradiation area, two long electrodes are generally provided facing each other via a space. Specifically, in order to generate plasma in a rectangular area having, for example, a longer side of 10 cm, generally, two electrodes each having a longer side of 10 cm are provided facing each other with a spacing of some millimeters, and a mixture of, for example, oxygen gas and argon gas is caused to pass through the space in a direction normal to the longitudinal direction. During passage of the mixture gas, high frequency current is applied to the electrodes, whereby plasma can be provided in the rectangular (longer side: 10 cm) area under atmospheric pressure.

Japanese Patent Application Laid-Open (kokai) No. 2006-196210 (by the present inventors) discloses an atmospheric plasma generator in which micro-hollow cathodes having a predetermined length are provided to face each other with a very small spacing and a gas is caused to flow through the space, to thereby generate plasma. Japanese Patent Application Laid-Open (kokai) No. 2003-109799 discloses an atmospheric plasma generator having concentric cylindrical electrodes extending in a longitudinal direction. In the plasma generator, a gas is caused to flow through the space between the two electrodes under electric discharge in a direction normal to the longitudinal direction, whereby the generated plasma is provided through the holes disposed in the outer cylinder and arranged along the axial direction. Also disclosed is a plasma generator having plate electrodes disposed in parallel and in the axial direction. A voltage is applied to the parallel electrodes to provide electric discharge between the electrodes, and a gas is caused to flow through the space between the electrodes in a direction normal to the axial direction, whereby a plasma is output in a direction normal to the axial direction. Japanese Kohyo (PCT) Patent Publication No. 2008-533666 discloses an atmospheric plasma generator having a hollow cylinder extending in the axial direction in which cylinder ring electrodes are disposed at the ends thereof so as to face each other. In the plasma generator, a gas is supplied in the axial direction, and electric discharge is provided in the space between the ring electrodes in the axial direction, whereby a plasma is output in the axial direction.

In the atmospheric plasma generators disclosed in Japanese Patent Application Laid-Open (kokai) Nos. 2006-196210 and 2003-109799, electric discharge is given between longitudinally extending electrodes facing each other, and a gas is supplied in a direction normal to the electric discharge direction. However, electric discharge is difficult to provide between the electrode under atmospheric pressure. In the atmospheric plasma generators disclosed in the patent documents, the electrodes disposed in opposition to each other have a large area. Therefore, when electric discharge initiates at certain spots in the surfaces of the electrodes to thereby give a large current flow, the voltage between the electrode suddenly drops in the course of electric discharge due to voltage drop in wiring to the electrodes. In this case, areas of the electrodes other than the spots of the electrodes cannot enjoy electric discharge, which is problematic. In other words, uniform atmospheric electric discharge is difficult to realize between wide electrodes. Thus, in the atmospheric plasma generators disclosed in those patent documents, even though a gas is caused to flow in a direction normal to the electric discharge direction, plasma with a uniform density is difficult to provide in a belt-like area of the plasma-irradiated surface.

In the plasma generator disclosed in Japanese Kohyo (PCT) Patent Publication No. 2008-533666, electric discharge is provided in the axial direction between the plate-like ring electrodes disposed at the longitudinal ends of the cylinder so as to face each other, and a gas is supplied in the axial direction via a center hole provided in each ring electrode, whereby a plasma is output in the axial direction. However, in this atmospheric plasma generator, uniform electric discharge is difficult to realize between the electrodes which are disposed in opposition to each other. In the plasma generator, a gas is caused to flow in a direction parallel to linear spot-to-spot electric discharge between the opposing electrodes. Therefore, plasma is difficult to output effectively in an elongated belt-like area of the plasma-irradiated surface, which is problematic.

### SUMMARY OF THE INVENTION

Thus, an object of the present invention is to provide an atmospheric plasma generator which can output plasma to a plasma-irradiated surface of a workpiece in a wide belt-like plane.

In a first aspect of the present invention, there is provided an atmospheric plasma generator comprising:

a casing which is made of an insulator and defines a columnar primary plasma-generating zone extending in the axial direction;

a first auxiliary plasma-generating section having:
a first gas outlet opening in the axial direction at one end of the primary plasma-generating zone,
a first electrode and a second electrode which are disposed at the first gas outlet and in a direction normal to the axial direction, the electrodes facing each other via a space, and
first gas-supplying means for supplying a gas of interest to the first gas outlet;

a second auxiliary plasma-generating section having:
a second gas outlet opening at the other end of the primary plasma-generating zone and toward the first gas outlet in the axial direction,
a third electrode and a fourth electrode which are disposed at the second gas outlet and in a direction normal to the axial direction, the electrodes facing each other via a space, and
second gas-supplying means for supplying a gas to the second gas outlet;

third gas-supplying means for supplying a gas of interest in a direction normal to the axial direction of the primary plasma-generating zone; and

third gas outlets through which a gas mixture plasma of the gases supplied through the first gas-supplying means, the second gas-supplying means, and the third gas-supplying means, the gas mixture plasma being formed in the primary plasma-generating zone, is jetted in a direction normal to the axial direction of the primary plasma-generating zone, and which gas outlets are provided along the axial direction of the primary plasma-generating zone.

A characteristic feature of the present invention resides in that the two auxiliary plasma gases emitted from the plasma-generating sections disposed in opposition to each other are employed as so-called thermal electrodes, that electric discharge is provided between the thermal electrodes, and that a gas of main interest is supplied perpendicularly to the electric discharge zone, to thereby generate a plasma of the gas. Therefore, in a space between the two facing electrodes extending in the axial direction, a plasma having a predetermined surface area is generated at a cross-section normal to the axial direction of the primary plasma-generating zone. As a result, a plasma plane having a predetermined area propagates in the axial direction of the primary plasma-generating zone, whereby a uniform plasma is generated in the entire primary plasma-generating zone defined by the insulator. Thus, a columnar electric discharge zone having a length as long as several meters can be formed, and a plasma of main interest can be jetted in a direction normal to the longitudinal direction, whereby a rectangular plasma irradiation area having a longer side as long as several meters can be obtained.

In the first aspect of the present invention, the first gas-supplying means for supplying a gas of interest disposed in the first auxiliary plasma-generating section and the second gas-supplying means for supplying a gas of interest disposed in the second auxiliary plasma-generating section may supply gases which are identical to or different from each other, or gas mixtures having compositions which are identical to or different from each other.

A second aspect of the present invention is a specific embodiment of the first aspect, wherein:

a voltage is applied to the first and second electrodes, to thereby generate a plasma between the electrodes through electric discharge,

a voltage is applied to the third and fourth electrodes, to thereby generate a plasma between the electrodes through electric discharge, and

a voltage is applied to the first and third electrodes, to thereby generate a plasma in the primary plasma-generating zone in the axial direction.

A third aspect of the present invention is a specific embodiment of the first or second aspect, wherein the plasma generator has a first power source for applying a voltage to the first and second electrodes, a second power source for applying a voltage to the third and fourth electrodes, and a third power source for applying a voltage to the first and third electrodes.

The voltage applied to the electrodes may be DC voltage, AC voltage, or DC-AC mixed voltage. In one mode, a DC voltage is applied to the first and second electrodes and to the third and fourth electrodes, and an AC voltage is applied to the first and third electrodes. Alternatively, an AC voltage is applied to the first and second electrodes and to the third and fourth electrodes, and a DC voltage is applied to the first and third electrodes. Yet alternatively, an AC and/or DC voltage are/is applied to the first and second electrodes, to the third and fourth electrodes, and to the first and third electrodes. Through application of voltage in such a manner, a uniform plasma extending in the axial direction of the entire primary plasma zone can be generated.

The third gas-supplying means for supplying a gas of interest may supply a gas which is identical to or different from a gas supplied through the first gas-supplying means disposed in the first auxiliary plasma-generating section or a gas supplied through the second gas-supplying means disposed in the second auxiliary plasma-generating section, or may supply a gas mixture having a composition which is identical to or different from the composition of the gas mixture supplied through the first or second gas-supplying means.

A fourth aspect of the present invention is a specific embodiment of any of the first to third aspects, wherein the primary plasma-generating zone has a length in the axial direction of 3 cm to 2 m.

A fifth aspect of the present invention is a specific embodiment of any of the first to fourth aspects, wherein the primary plasma-generating zone has a square or rectangular cross-section having a side that is normal to the axial direction and the direction of supplying gas through the third gas-supplying means of 0.1 mm to 1 cm, and a side that is parallel to the axial direction and the direction of supplying gas through the third gas-supplying means of 5 mm to 2 cm.

A sixth aspect of the present invention is a specific embodiment of any of the first to fifth aspects, wherein a plurality of the third gas outlets are disposed in the primary plasma-generating zone along the axial direction.

A seventh aspect of the present invention is a specific embodiment of any of the first to sixth aspects, wherein the third gas-supplying means has a plurality of holes which open to the primary plasma-generating zone in a direction normal to the axial direction of the primary plasma-generating zone and which are arranged along the axial direction.

In all the aforementioned aspects of the invention, the first gas-supplying means for supplying a gas to the first gas outlet or the second gas-supplying means for supplying a gas to the second gas outlet may be argon gas-supplying means. The third gas-supplying means may be oxygen gas-supplying means.

A characteristic feature of the present invention resides in that the longitudinal direction of the rectangular plasma irradiation area to be realized coincides with the longitudinal direction of the primary plasma-generating zone or the electric discharge zone, whereby an elongated columnar plasma-generating zone or a long electric discharge path can be formed.

The two auxiliary plasma gases emitted from the plasma-generating sections disposed in opposition to each other are considered charged particles emitted by thermal electrodes. Between the first electrode and the second electrode, and between the third electrode and the fourth electrode, electric discharge is provided to thereby generate an auxiliary plasma between the respective pairs of electrodes. Then, through application of a voltage to the first and third electrodes, an auxiliary plasma generated at each end of the primary plasma-generating zone in the axial direction propagates in the axial direction of the primary plasma-generating zone, whereby a uniform plasma is generated in the entire primary plasma-generating zone (columnar space) defined by the insulator.

Subsequently, a gas of a main plasma source is supplied in a direction normal to the axial direction of the primary plasma-generating zone, to thereby generate a plasma of the gas in the columnar space. For example, a third gas, which differs from the gas for forming the two auxiliary plasmas; e.g., a mixture of inert gas and oxygen, is supplied in a direction normal to the axial direction. The atoms or molecules of the third gas form corresponding ions, excited molecules, and radicals. When oxygen molecules are present, ozone molecules are formed.

Therefore, in a space between the two electrodes extending in the axial direction, a plasma having a predetermined surface area is generated at a cross-section normal to the axial direction of the primary plasma-generating zone. As a result, a plasma plane having a predetermined area propagates in the axial direction of the primary plasma-generating zone, whereby a uniform plasma is generated in the entire primary plasma-generating zone defined by insulator. Thus, a columnar electric discharge zone having a length as long as several meters can be formed in the axis direction, and a plasma of main interest can be jetted in a direction normal to the longitudinal direction, whereby a rectangular plasma irradiation area having a longer side as long as several meters can be obtained. Through supplying an oxygen-containing gas in a direction normal to the longitudinal primary plasma-generating zone or electric discharge zone, a rectangular oxygen plasma irradiation area having a long side corresponding to the length of the electric discharge zone can be formed. According to the plasma generator, a longitudinal rectangular oxygen plasma irradiation region can be formed through one step. Thus, even a large-area workpiece can be subjected to oxygen plasma treatment at process high rate. The aforementioned oxygen gas is merely an example, and needless to say, other gases may be employed.

Notably, the present invention can be applied to any plasma-generating species, and the aforementioned mixture of argon and oxygen may be altered to, for example, any other gases, aerosol, or microparticle-dispersed gas.

### BRIEF DESCRIPTION OF THE DRAWINGS

Various other objects, features, and many of the attendant advantages of the present invention will be readily appreciated as the same becomes better understood with reference to the following detailed description of the preferred embodiments when considered in connection with the accompanying drawings, in which:

FIG. 1 is a sketch of a plasma generator 100 according to one embodiment of the present invention;

FIG. 2A is a cross-section taken parallel to the axial direction of the plasma generator 100;

FIG. 2B is a cross-section taken normal to the axial direction of the first auxiliary plasma-generating section of the plasma generator 100; and

FIG. 3 is a cross-section of the plasma generator 100 in operation.

### DETAILED DESCRIPTION OF PREFERRED EMBODIMENTS

Hereinafter, an embodiment of the present invention will be described with reference to the drawings. However, the embodiment should not be construed as limiting the invention thereto.

### EMBODIMENT

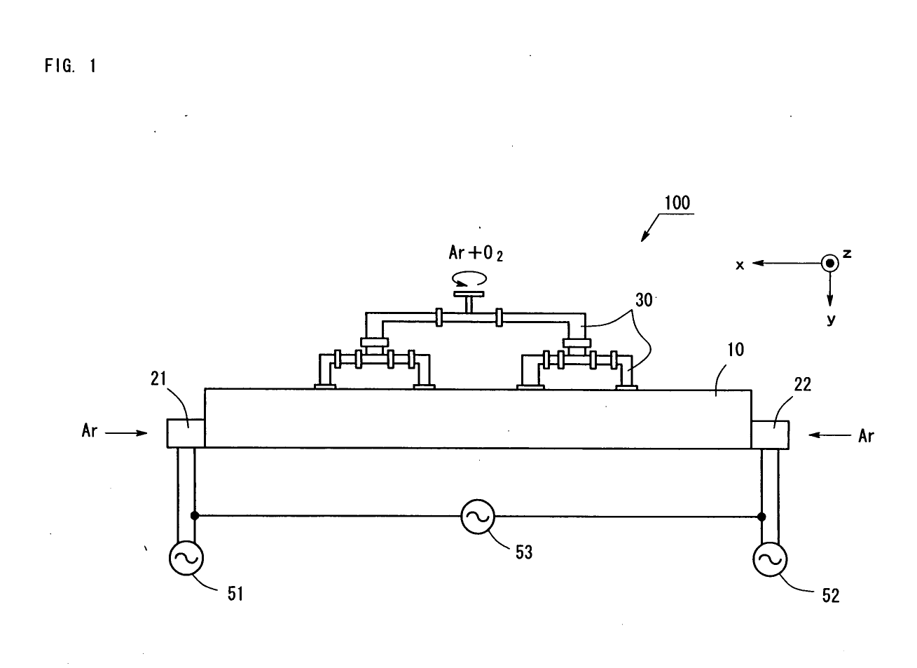

FIG. 1 is a sketch of an atmospheric plasma generator 100 according to one specific embodiment of the present invention. The atmospheric plasma generator 100 shown in FIG. 1 generates plasma that requires neither reduction in pressure nor air shielding. In FIG. 1, the plasma generator 100 has a generally rectangular parallelpiped casing 10; a first auxiliary plasma-generating section 21 and a second auxiliary plasma-generating section 22, which are disposed at respective longitudinal (x-axial direction) ends of the casing 10; gas mixture (argon and oxygen)-supplying pipes 30 (third gas-supplying means) which are connected to the upper portion of the casing 10; and three high-frequency power sources 51, 52, and 53 (first power source, second power source, and third power source).

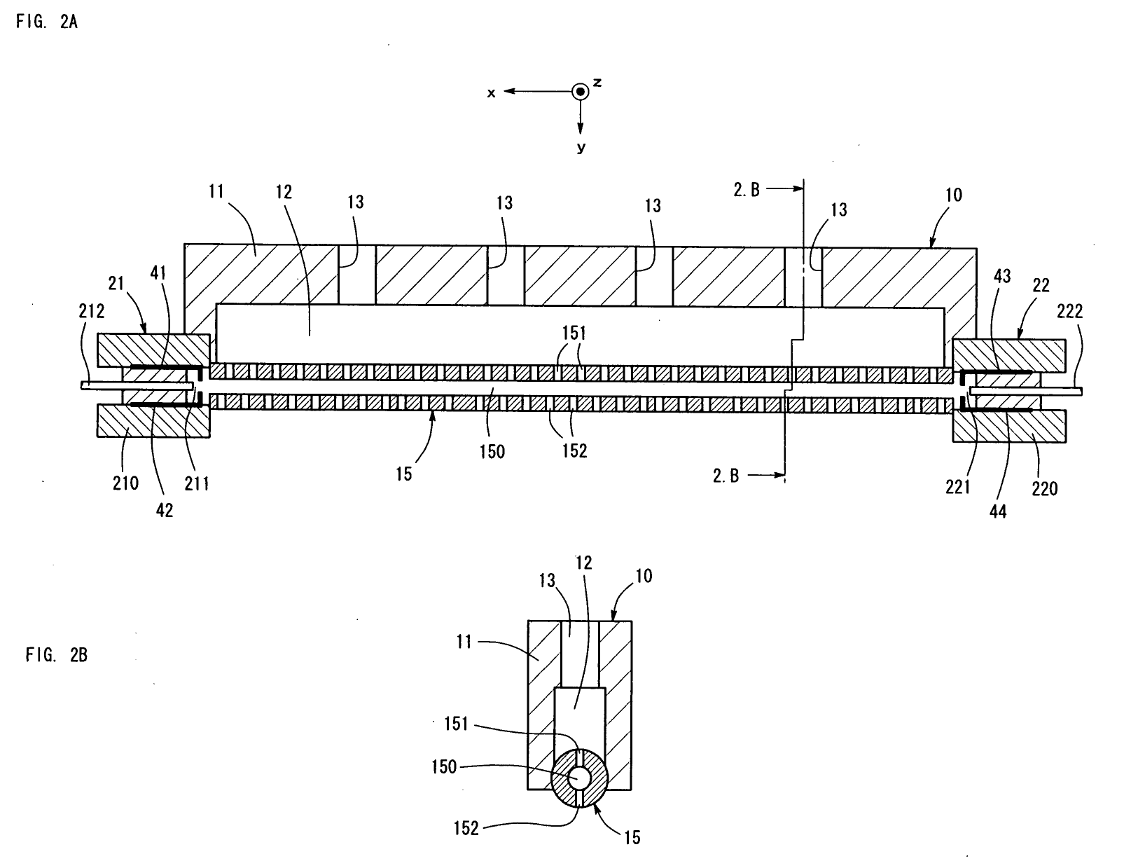

FIG. 2A is a cross-section taken parallel to the axis (x-axis) direction of the casing 10 of the plasma generator 100 shown in FIG. 1, and FIG. 2B is a cross-section taken normal to the axis (x-axis) direction of the first auxiliary plasma-generating section 21 of the plasma generator 100. The casing 10 has a generally rectangular parallelpiped outer casing 11 and a cylindrical section 15 extending in the x-axial direction. The cylindrical section 15 is made of an electrical insulator and has a length in the x-axial direction of about 50 cm. Along the x-axial direction, the cylindrical section is provided with 170 first holes 151 and 170 second holes 152. The columnar inner space of the cylindrical section 15 forms a primary plasma-generating zone 150 (electric discharge zone). The outer casing 11, which is made of an insulator, is formed of an internal space 12 and four inlets 13 for connecting, at the upper section thereof, the gas mixture (argon and oxygen)-supplying pipes 30.

The cylindrical section 15 is inserted to the lower section of the internal space 12 in the outer casing 11, to thereby form the casing 10. The 170 first holes 151 of the cylindrical section 15 are provided on the side of the internal space 12, and the 170 second holes 152 open to the outside.

To the longitudinal ends of the cylindrical section 15, the first auxiliary plasma-generating section 21 and the second auxiliary plasma-generating section 22 are connected.

The first auxiliary plasma-generating section 21 connected to the end (left in FIG. 2A) of the cylindrical section 15 has the following members. Specifically, a first gas outlet 211 is provided so as to communicate with the primary plasma-generating zone (electric discharge zone) 150 of the cylindrical section 15, and a first electrode 41 and a second electrode 42 are disposed so as to sandwich the first gas outlet 211. By the mediation of the first gas outlet 211, an argon-supplying pipe 212 is provided so that argon can be supplied to the primary plasma-generating zone (electric discharge zone) 150 of the cylindrical section 15 in the x-axial direction. A fixation part 210 made of an insulator is provided in order to fix the first electrode 41, the second electrode 42, and the argon-supplying pipe 212.

Similarly, the second auxiliary plasma-generating section 22 connected to the end (right in FIG. 2A) of the cylindrical section 15 has the following members. Specifically, a second gas outlet 221 is provided so as to communicate with the primary plasma-generating zone (electric discharge zone) 150 of the cylindrical section 15, and a third electrode 43 and a fourth electrode 44 are disposed so as to sandwich the second gas outlet 221. By the mediation of the second gas outlet 221, an argon-supplying pipe 222 is provided so that argon can be supplied to the primary plasma-generating zone (electric discharge zone) 150 of the cylindrical section 15 in the x-axial direction. A fixation part 220 made of an insulator is provided in order to fix the third electrode 43, the fourth electrode 44, and the argon-supplying pipe 222.

As shown in FIG. 2A, argon is supplied along the -x-axis direction from the left end of the primary plasma-generating zone (electric discharge zone) 150 of the cylindrical section 15 to the x-axis mid portion of the zone, via the argon-supplying pipe 212 and the first gas outlet 211 of the first auxiliary plasma-generating section 21. Similarly, argon is supplied along the x-axis direction from the right end of the primary plasma-generating zone (electric discharge zone) 150 of the cylindrical section 15 to the x-axis mid portion of the zone, via an argon-supplying pipe 222 and the second gas outlet 221 of a second auxiliary plasma-generating section 22. In this way, the first gas outlet 211 of the first auxiliary plasma-generating section 21 and the second gas outlet 221 of the second auxiliary plasma-generating section 22 are separately disposed along the x-axis so as to face each other.

FIG. 2B is a cross-section of the plasma generator shown in FIG. 2A, as viewed from the dashed dotted lines 2.B, 2.B in FIG. 2A. As described above, the cylindrical section 15 is inserted to the lower section of the internal space 12 in the outer casing 11, to thereby form the casing 10. The cylindrical section 15 is provided with the 170 first holes 151 opening to the internal space 12, and with the 170 second holes 152 opening to the outside (y-axial direction) arranged along the x-axis direction.

Notably, the first holes 151 and the second holes 152 are formed in a columnar side wall, and each opening of the column has a diameter of 1 mm. As shown in FIG. 2B, the central axis of one first hole 151 does not coincide with that of a corresponding second hole 152, so that the gas supplied through the gas mixture-supplying pipes 30 via the internal space 12 is uniformly dispersed in the primary plasma-generating zone 150. Thus, the plasma generated in the primary plasma-generating zone 150 has uniformity in plasma density.

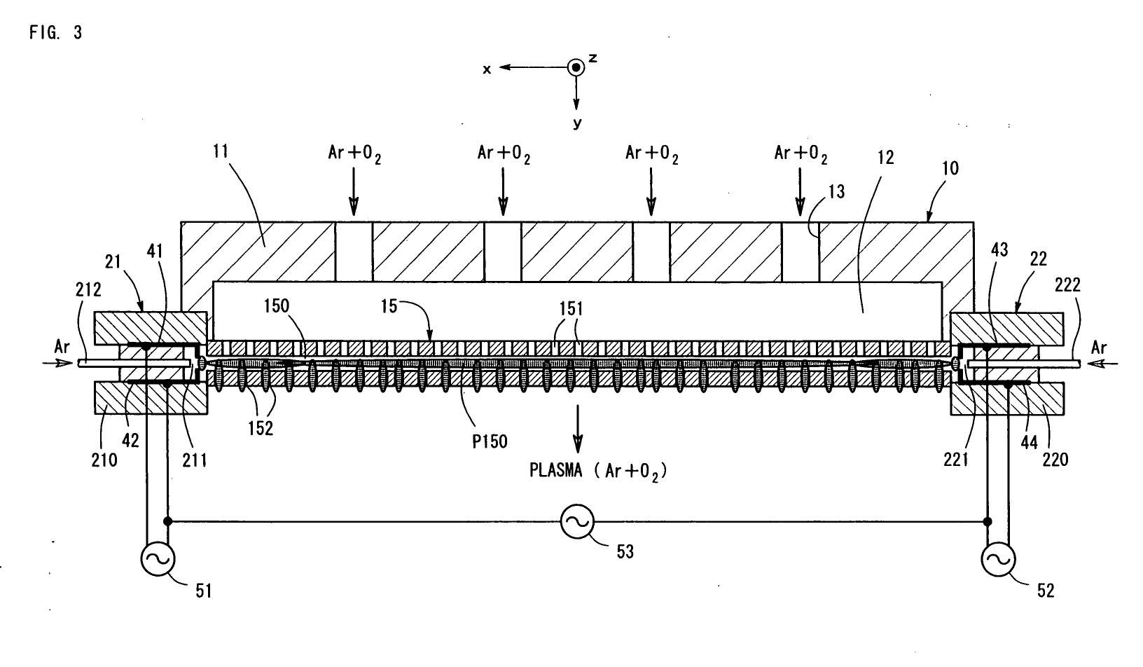

FIG. 3 is a conceptual representation showing the plasma generator 100 shown in FIG. 1 in operation, with a plasma generation state in the primary plasma-generating zone 150 and irradiation of a workpiece with plasma under the x-axis 50-cm region. In FIG. 3, the same structural elements as employed in FIGS. 1, 2A, and 2B are denoted by the same reference numerals, and detailed descriptions thereof are omitted.

The first high-frequency power source 51 is connected to the first electrode 41 and the second electrode 42 of the first auxiliary plasma-generating section 21. The second high-frequency power source 52 is connected to a third electrode 43 and a fourth electrode 44 of the second auxiliary plasma-generating section 22. The third high-frequency power source 53 is connected to the first electrode 41 of the first auxiliary plasma-generating section 21 and the third electrode 43 of the second auxiliary plasma-generating section 22. The first electrode 41 and the second electrode 42 extend in the -x-axial direction, and the tips thereof are bent in the y-axis and the -y-axial directions, respectively, so as to face each other.

Argon (Ar) is supplied through the first argon-supplying pipe 212 to the inside of the cylindrical section 15 from the left end in the -x-axial direction (in FIG. 3), and argon (Ar) is also supplied through the second argon-supplying pipe 222 to the inside of the cylindrical section 15 from the right end in the x-axial direction (in FIG. 3).

In this way, an argon flow at the first gas outlet 211 of the first auxiliary plasma-generating section 21 forms argon plasma by application of high-frequency electric power between the first electrode 41 and the second electrode 42, and the plasma is jetted as an auxiliary plasma in the -x-axial direction from the left end of the primary plasma-generating zone (electric discharge zone) 150 to the inside of the cylindrical section 15. Similarly, an argon flow at a second gas outlet 221 of the second auxiliary plasma-generating section 22 forms argon plasma by application of high-frequency electric power between the third electrode 43 and the fourth electrode 44, and the plasma is jetted as an auxiliary plasma in the x-axial direction from the right end of the primary plasma-generating zone (electric discharge zone) 150 to the inside of the cylindrical section 15.

In this state, when high-frequency electric power is applied by means of the third high-frequency power source 53 to the first electrode 41 of the first auxiliary plasma-generating section 21 and the third electrode 43 of the second auxiliary plasma-generating section 22, electric discharge occurs between two auxiliary plasmas (argon plasmas) flowing from respective ends of the primary plasma-generating zone (electric discharge zone, columnar space) 150. Through the electric discharge, the discharge state is maintained in the entire primary plasma-generating zone (electric discharge zone, columnar space) 150, which serves as a plasma-generating zone.

To the thus-electric-discharged primary plasma-generating zone (electric discharge zone) 150, oxygen and argon are supplied through the gas mixture (argon and oxygen)-supplying pipes 30 via the inlets 13, the internal space 12, and the first holes 151, in a direction normal to the axis of the primary plasma-generating zone 150 (y-axial direction). Thus, the oxygen supplied to the primary plasma-generating zone 150 is ionized, radicalized, or activated (excitation of oxygen molecules), or ozone is formed through reaction occurring in the zone, whereby oxygen plasma P150 is generated. The oxygen plasma P150 flows along the oxygen gas supply direction (y-axis) and is jetted through the 170 second holes 152 disposed at the bottom side wall of the cylindrical section 15 to the outside of the wall of the cylindrical section 15 in a direction normal to the side wall (y-axis), as shown in FIG. 3.

The 170 second holes 152 disposed at the bottom side wall of the cylindrical section 15 have a diameter of 1 mm and are arranged in line in the x-axial direction over a range of about 50 cm. Through jetting the plasma through the holes 152 to the outside, oxygen plasma P150 in the form of a belt-like area (width: 50 cm) is output.

Accordingly, the plasma generator 100 shown in FIG. 1 is a useful atmospheric plasma generator which does not require reduction in pressure or air shielding.

The length in the axis (x-axis) direction of the primary plasma-generating zone 150 can be realized to 2 m or shorter. No particular limitation is imposed on the lower limit of the length, but the length is preferably adjusted to 3 cm or longer. In the Embodiment, the primary plasma zone is formed of a cylinder having an inner diameter of 2 mm. Alternatively, the zone may be formed of a rectangular parallelpipe having a rectangular cross-section (normal to the x-axis of the primary plasma-generating zone 150). When a rectangular cross-section is employed, the longer or shorter side preferably has a length of 2 mm to 5 mm. The cross-section is preferably a square or a rectangle, so long as the side length falls within the range of 2 mm to 5 mm. When the lengths fall within the range, the x-axis length of the primary plasma-generating zone 150 can be adjusted to 2 m or shorter. The cross-sectional area is preferably 3 mm² to 25 mm². To the 170 second holes 152 of the cylindrical section 15, a plurality of other holes having a y-axis length of about 5 cm may be connected and arranged along the x-axial direction. In this case, the additional holes may be slanted with respect to the y-axis.

The atmospheric plasma generator of the invention can be employed for cleaning glass substrates employed as liquid crystal display panels and other display substrates; cleaning a variety of semiconductor substrates; removing impurities on surfaces of workpieces; sterilizing; etc. The present invention is particularly suitable for continuous treatment of plates and films having a large area under atmospheric pressure.

1. An atmospheric plasma generator comprising:
a casing which is made of an insulator and defines a columnar primary plasma-generating zone extending in the axial direction;
a first auxiliary plasma-generating section having:
a first gas outlet opening in the axial direction at one end of the primary plasma-generating zone,
a first electrode and a second electrode which are disposed at the first gas outlet and in a direction normal to the axial direction, the electrodes facing each other via a space, and
first gas-supplying means for supplying a gas of interest to the first gas outlet;
a second auxiliary plasma-generating section having:
a second gas outlet opening at the other end of the primary plasma-generating zone and toward the first gas outlet in the axial direction,
a third electrode and a fourth electrode which are disposed at the second gas outlet and in a direction normal to the axial direction, the electrodes facing each other via a space, and
second gas-supplying means for supplying a gas to the second gas outlet;
third gas-supplying means for supplying a gas of interest in a direction normal to the axial direction of the primary plasma-generating zone; and
third gas outlets through which a gas mixture plasma of the gases supplied through the first gas-supplying means, the second gas-supplying means, and the third gas-supplying means, the gas mixture plasma being formed in the primary plasma-generating zone, is jetted in a direction normal to the axial direction of the primary plasma-generating zone, and which gas outlets are provided along the axial direction of the primary plasma-generating zone.

2. An atmospheric plasma generator according to claim 1, wherein:
a voltage is applied to the first and second electrodes, to thereby generate a plasma between the electrodes through electric discharge,
a voltage is applied to the third and fourth electrodes, to thereby generate a plasma between the electrodes through electric discharge, and
a voltage is applied to the first and third electrodes, to thereby generate a plasma in the primary plasma-generating zone in the axial direction.

3. An atmospheric plasma generator according to claim 1, which includes a first power source for applying a voltage to the first and second electrodes, a second power source for applying a voltage to the third and fourth electrodes, and a third power source for applying a voltage to the first and third electrode.

4. An atmospheric plasma generator according to claim 2, which includes a first power source for applying a voltage to the first and second electrodes, a second power source for applying a voltage to the third and fourth electrodes, and a third power source for applying a voltage to the first and third electrode.

5. An atmospheric plasma generator according to claim 1, wherein the primary plasma-generating zone has a length in the axial direction of 3 cm to 2 m.

6. An atmospheric plasma generator according to claim 2, wherein the primary plasma-generating zone has a length in the axial direction of 3 cm to 2 m.

7. An atmospheric plasma generator according to claim 3, wherein the primary plasma-generating zone has a length in the axial direction of 3 cm to 2 m.

8. An atmospheric plasma generator according to claim 4, wherein the primary plasma-generating zone has a length in the axial direction of 3 cm to 2 m.

9. An atmospheric plasma generator according to claim 1, wherein the primary plasma-generating zone has a square or rectangular cross-section having a side that is normal to the axial direction and the direction of supplying gas through the third gas-supplying means of 0.1 mm to 1 cm, and a side that is parallel to the axial direction and the direction of supplying gas through the third gas-supplying means of 5 mm to 2 cm.

10. An atmospheric plasma generator according to claim 2, wherein the primary plasma-generating zone has a square or rectangular cross-section having a side that is normal to the axial direction and the direction of supplying gas through the third gas-supplying means of 0.1 mm to 1 cm, and a side that is parallel to the axial direction and the direction of supplying gas through the third gas-supplying means of 5 mm to 2 cm.

11. An atmospheric plasma generator according to claim 3, wherein the primary plasma-generating zone has a square or rectangular cross-section having a side that is normal to the axial direction and the direction of supplying gas through the third gas-supplying means of 0.1 mm to 1 cm, and a side that is parallel to the axial direction and the direction of supplying gas through the third gas-supplying means of 5 mm to 2 cm.

12. An atmospheric plasma generator according to claim 5, wherein the primary plasma-generating zone has a square or rectangular cross-section having a side that is normal to the axial direction and the direction of supplying gas through the third gas-supplying means of 0.1 mm to 1 cm, and a side that is parallel to the axial direction and the direction of supplying gas through the third gas-supplying means of 5 mm to 2 cm.

13. An atmospheric plasma generator according to claim 1, wherein a plurality of the third gas outlets are disposed in the primary plasma-generating zone along the axial direction.

14. An atmospheric plasma generator according to claim 2, wherein a plurality of the third gas outlets are disposed in the primary plasma-generating zone along the axial direction.

15. An atmospheric plasma generator according to claim 3, wherein a plurality of the third gas outlets are disposed in the primary plasma-generating zone along the axial direction.

16. An atmospheric plasma generator according to claim 5, wherein a plurality of the third gas outlets are disposed in the primary plasma-generating zone along the axial direction.

17. An atmospheric plasma generator according to claim 9, wherein a plurality of the third gas outlets are disposed in the primary plasma-generating zone along the axial direction.

18. An atmospheric plasma generator according to claim 1, wherein the third gas-supplying means has a plurality of holes which open to the primary plasma-generating zone in a direction normal to the axial direction of the primary plasma-generating zone and which are arranged along the axial direction.

19. An atmospheric plasma generator according to claim 3, wherein the third gas-supplying means has a plurality of holes which open to the primary plasma-generating zone in a direction normal to the axial direction of the primary plasma-generating zone and which are arranged along the axial direction.

20. An atmospheric plasma generator according to claim 16, wherein the third gas-supplying means has a plurality of holes which open to the primary plasma-generating zone in a direction normal to the axial direction of the primary plasma-generating zone and which are arranged along the axial direction.
